(19) United States
(12) Patent Application Publication
(10) Pub. No.: US 2016/0166364 A1
(43) Pub. Date: Jun. 16, 2016

(54) APPARATUS AND METHOD FOR DENTAL FLOSSING

(71) Applicant: Robert J. Goldston, Princeton, NJ (US)

(72) Inventor: Robert J. Goldston, Princeton, NJ (US)

(21) Appl. No.: 14/972,812

(22) Filed: Dec. 17, 2015

Related U.S. Application Data
(60) Provisional application No. 62/092,224, filed on Dec. 15, 2014.
(60) Provisional application No. 62/125,784, filed on Feb. 2, 2015.

(51) Int. Cl. A61C 15/04

(52) U.S. Cl. CPC A61C 15/046; A61C 15/043

(57) ABSTRACT

An apparatus and method for dental flossing is provided. The apparatus includes a first and second floss stick, each of which includes an elongated base portion, a top portion, where the top portion includes a slot or other means to thread floss, and a narrow neck. A segment of floss is wrapped between the first floss stick and second floss stick, such that the segment of floss is initially wrapped over the slot, or other threading means, and then around the narrow neck portion in the first floss stick, and then wrapped over the slot, or other threading means, and around the narrow neck portion of the second floss stick. One or both of the floss sticks may contain reels of floss. The method for dental flossing includes the steps of gripping the apparatus by the elongated base portions of the first and second floss sticks in each hand; separating the first and second floss sticks; flossing teeth by using thumbs or forefingers placed on the floss between the first and second floss sticks to guide the floss; rotating the first and second floss sticks to move fresh floss from the first floss stick and used floss to the second floss stick between flossing of gaps between the teeth; and removing used floss when finished by pulling the floss straight upwards off the tops of the first and second floss sticks.

### CROSS-REFERENCE TO RELATED APPLICATIONS

This application claims priority to provisional applications 62/092,224 and 62/125,784, filed on Jan. 14, 2015 and Feb. 25, 2015 respectively, which are herein incorporated by reference.

### FIELD OF THE INVENTION

The present invention relates to dental flossing tools; specifically, elongated floss sticks between which dental floss is threaded.

### BACKGROUND OF THE INVENTION

Dental floss is generally a bundle of thin nylon filaments or a plastic ribbon used to remove food and dental plaque from teeth. The floss is gently inserted between the teeth and scraped along the teeth sides, especially close to the gums. Dental floss may be flavored or unflavored, and waxed or unwaxed. Dental floss is commonly supplied in plastic dispensers that contain about 40 to 60 yards of floss. After pulling out the desired amount, the floss is pulled against a small protected blade in the dispenser to sever it. Dental floss is commonly held between the fingers and guided into the gap between each pair of teeth and under the gumline to remove particles of food stuck between teeth and dento-bacterial plaque that adhere to such dental surfaces. Typically, the floss is curved around a tooth and placed under the gumline, and then moved away from the gumline, scraping the side of each tooth and also cleaning the front or back of the tooth. Gently moving the floss from below the gumline to away from the gumline removes dento-bacterial plaque attached to teeth surfaces above and below the gumline. A clean section of floss should be used to clean each tooth to avoid transmitting plaque bacteria from one tooth to another.

A skilled dental hygienist guides dental floss between the teeth of a patient using the thumb and forefinger of both hands, maintaining tension on the floss using his or her wrists. As floss accumulates food particles or becomes damaged, the hygienist feeds additional floss from one hand to the other, making fresh floss available for the next flossing action. The fresh floss for this use is typically coiled on the middle or ring finger of one hand. A growing coil of used floss is typically maintained on the other hand in order to exert proper tension on the floss currently in use.

A problem arises for many non-professional users where the tension required to properly guide dental floss between the teeth can be high enough such that the coils of floss exert uncomfortable pressure on the fingers around which they are wound. This is particularly true for individuals with tightly spaced teeth. Further, another problem occurs when users suffer from a sensitive gag reflex, which can be triggered when placing multiple fingers in the mouth to reach the farther back teeth. Moreover, an additional problem follows where coiling used floss on one hand can be unpleasant, particularly if the used floss contains particles of food or blood on it. It is also difficult to present fresh floss at each of the gaps between teeth. These problems can lead to less frequent flossing or a lack of flossing, which can cause bleeding gums, gingivitis, or other serious diseases.

Specialized wands or floss picks have been produced to hold the floss. These may be attached to or separate from a floss dispenser. While wands do not pinch fingers like regular floss can, and the enhanced reach of a wand can make flossing the back teeth easier, using a wand may be awkward and can also make it difficult to floss at all angles possible with regular floss and run the risk of missing the area under the gum line that needs to be flossed. Ergonomic tools have also been produced. These include improved handles for better grip and swiveling floss heads which allow easy access to any pair of teeth in the mouth. Their floss heads also feature a lateral flexibility that enables improved control for the dental floss to hug the sides of the teeth and clean under the gum line without the danger of hurting the gums. However, these systems do not allow a user to present fresh floss at each of the gaps between teeth. They also generally are discarded after a single use, leading to excessive plastic waste in addition to the used floss.

An example of improvements made in the field related to the present invention is described below and are herein incorporated by reference. U.S. Pat. No. 6,019,109, issued to Moore, discloses a dental flossing tool and method for flossing teeth using that tool. The tool includes two elongated, rod-shaped handle elements and a length of dental floss that is removably secured at its opposite ends to respective ones of the handle elements at their terminal ends. Each handle element is provided with a bulb at the terminal end to which the floss is attached with the bulbs being larger in transverse cross-section relative to the longitudinal axis of its handle element than is the adjacent portion of the handle element. This results in a depressed annular region in which floss is wound and functions to retain the floss on a handle element. Each handle element includes a hand-grip section disposed in remote relationship to the terminal end provided with a bulb enabling a user to grip the element in a respective hand for support thereof and independent manipulation in effecting a flossing operation. The user holds the handle elements in separated relationship to maintain the floss extending between the terminal ends taut as an operative flossing section while inserting it between a pair of adjacent teeth and moving it to effect removal of debris. At intermittent intervals the user revolves the handle elements to concurrently unreel a length of floss from one and reel a length onto the other thereby placing an unused section of floss in an operative position and placing the previously used section on a handle element for storage until being discarded upon termination of a flossing operation.

Another example in the field related to the present invention is US Patent Application No. 2014/0090662, which is herein incorporated by reference. This application teaches a flossing kit and tool including a floss cartridge which has a length of floss and a pair of tip members, each fixedly coupled to opposite ends of the length of floss. The flossing tool further includes a pair of floss handles each removably coupled to one of the pair of tip members respectively. The user grasps the floss handles with each hand and inserts the length of floss and tip members into his or her mouth in order to floss. When finished flossing the user removes the floss cartridge from the floss handles and discards it.

The inventions heretofore referenced suffer from one or more of a number of disadvantages which include being limited in application and use, being too large, being difficult to use and/or re-use, particularly when gripping handles that are remotely located from the teeth, not presenting fresh floss at each gap between teeth, being expensive, being difficult to manufacture, failing to adequately clean between teeth, damaging gums, not clearly communicating to a user when a device has already been used, requiring significant manual dexterity to operate, causing additional waste, and the like. What is needed is a flossing device that solves the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available flossing apparatuses. Accordingly, the present invention has been developed to provide a flossing apparatus that has the flexibility and ease of manual flossing without the pain associated with pressure from the coils of fresh and used floss around the fingers, presenting fresh floss at each tooth gap, and with a reduced tendency to gag when flossing the teeth in the back of the mouth.

According to one embodiment of the present invention, an apparatus for dental flossing is provided. The apparatus includes first and second floss sticks, each subsequently comprising an elongated base portion, a top portion, and a narrow neck portion. The top portion includes a slot on which to thread and hold the floss in place. The narrow neck portion is between the elongated base portion and top portion, and curves inward such that the width of the narrow neck portion is less than the width of the elongated base portion and top portion. Further, a segment of floss is wrapped between the first floss stick and second floss stick, such that the majority of the floss is initially wrapped over the slot in the first floss stick, then wrapped around the narrow neck portion of the first floss stick. The opposite end is then wrapped over the slot and around the narrow neck portion in the second floss stick.

According to another embodiment of the present invention, an apparatus for dental flossing is provided. The apparatus includes first and second cylindrical floss sticks, each subsequently comprising an elongated base portion, a top portion, and a narrow neck portion. The top portion includes a beveled hole through which to thread and hold the floss in place. The narrow neck portion is between the elongated base portion and top portion, and curves inward such that the diameter of the narrow neck portion is less than the diameter of the elongated base portion and top portion. Further, a segment of floss is wrapped between the first cylindrical floss stick and second cylindrical floss stick, such that the majority of the floss is initially wrapped through the beveled hole in the first cylindrical floss stick, then wrapped around the narrow neck portion of the first cylindrical floss stick. The opposite end in then wrapped through the beveled hole and around the narrow neck portion in the second cylindrical floss stick.

According to another aspect of the present invention, a method for dental flossing is provided. The method includes the steps of a user first gripping the apparatus of either embodiment described in the preceding paragraphs by the elongated base portions of the first and second floss sticks in each hand. Then, the user separates the first and second floss sticks to maintain tension in the dental floss between the first and second floss sticks. Then, the user flosses his or her teeth by using his or her thumbs or forefingers placed on the floss between the first and second floss sticks to guide the floss. Then, the user rotates the first and second floss sticks to move fresh floss from the first floss stick and used floss to the second floss stick after a gap between teeth is completed. This allows an appropriate length of fresh floss to be presented at each gap between teeth. Last, the user easily removes used floss when finished by pulling the floss straight upwards off the tops of the first and second floss sticks.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is noted that the drawings of the invention are not to scale. The drawings are mere schematic representations, not intended to portray specific parameters of the invention. Understanding that these drawings depict only typical embodiments of the invention and are not, therefore, to be considered to be limiting its scope, the invention will be described and explained with additional specificity and detail through the use of the accompanying drawings, in which:

FIG. 1 is a perspective view of a dental flossing apparatus according to one embodiment of the invention;

FIG. 2 is a perspective view of a floss stick according to one embodiment of the invention;

FIG. 3 is a perspective view of a floss stick according to an alternative embodiment of the invention;

FIG. 4 is a perspective view of a floss stick including a segment of floss as wrapped a few times around the floss stick, according to one embodiment of the invention; and

FIG. 5 is a perspective view of the dental flossing apparatus of an embodiment of the present invention in use.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

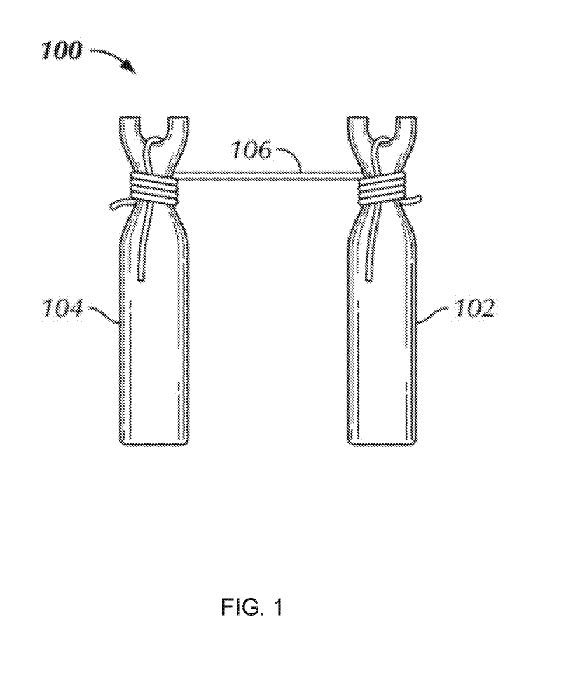

FIG. 1 is a perspective view of a dental flossing apparatus 100 according to one embodiment of the invention. The dental flossing apparatus 100 includes a first floss stick 102 and a second floss stick 104. The first floss stick 102 and second floss stick 104 are typically identical although they can differ in size and shape depending on the preference of a user, a manufacturer, or an embodiment which stores floss inside of one of the sticks. A segment of floss 106 is threaded between the first floss stick 102 and second floss stick 104. The segment of floss 106 is typically about 36″ although it can be any length the user prefers as long as it is enough to wrap around the first floss stick 102 and second floss stick 104, and supports dispensing the desired amount of fresh floss. The segment of floss 106 can also be any type of floss, from any type of floss dispenser the user prefers. The floss sticks 102 and 104 will be held in the hands of the user, separated relatively widely during use to create appropriate tension in the floss 106. Generally the floss sticks will not enter into the mouth of the user. The flossing apparatus could be fashioned from wood, molded plastic, or any other appropriate material.

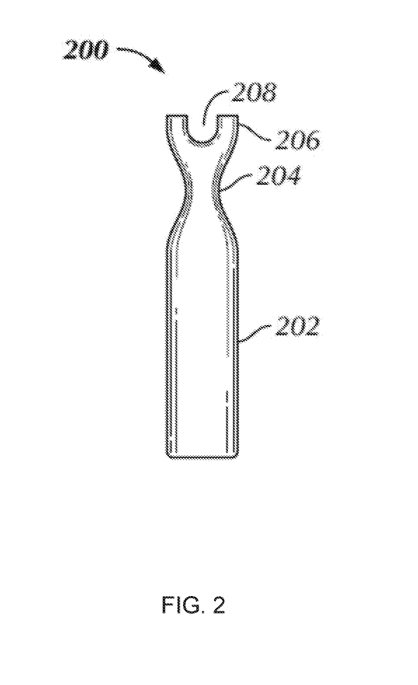

FIG. 2 is a perspective view of a floss stick 200 according to one embodiment of the invention. The floss stick 200 comprises an elongated base portion 202, a top portion 204, and a narrow neck portion 206 between the base portion 202 and top portion 204. The elongated base portion 202 is used for gripping the floss stick 200 while the user threads the floss and flosses their teeth. Gripping means (not shown) can be included on the elongated based portion 202 to aid the user in holding the floss stick 200. The top portion 206 comprises a slot 208 through which the floss is wrapped through to allow the user to wrap the majority of the floss on the first stick and a small amount on the second floss stick. The narrow portion 204 concaves inward and is used to wrap the floss around and keep appropriate tension on the portion of floss being used to clean the user's teeth. The narrow portion 204 could be a smooth inward curve, or an abrupt block-like inner portion, or any other appropriate shape around which to wrap the floss.

In a preferred but not limiting embodiment, each floss stick 200 is cylindrically shaped and about 5″ in length. The elongated base portion 202 is about ½″ in diameter and about 4 ¼″ in length. The narrow neck portion 204 is about ½″ in length and about 5/16″ in diameter. The inward curve creates an inner arc such that it would fit a circle of about ⅝″ in diameter. The top portion 206 is about ¼″ in length and ½″ in diameter, while the slot 208 is about ⅛″ in width and 3/16″ in depth. Other shapes and sizes can be used as well; for instance, the floss stick 200 can be rectangular or triangular prism shaped. Deviations in measurements can be accomplished as well based on the preferences of a manufacturer.

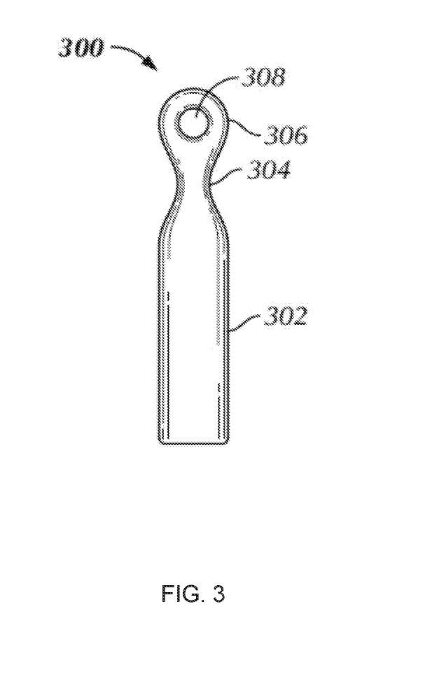

FIG. 3 is a perspective view of a floss stick 300 according to an alternative embodiment of the invention. The floss stick 300 comprises an elongated base portion 302, top portion 306, and narrow neck portion 304 between the elongated base portion 302 and top portion 306. The base portion 302 and neck portion 304 are similar to the embodiment in FIG. 2. The top portion 306 comprises a beveled hole 308 through which the floss is threaded instead of a slot to hold the floss.

In a preferred but not limiting embodiment, each floss stick 300 is cylindrically shaped and about 5″ in length. The elongated base portion 302 is about ⅜″ in diameter and about 4¼ ″ in length. The narrow neck portion 304 is about ½″ in length and about ¼″ in diameter. The inward curve creates an inner arc such that it would fit a circle of about ⅝″ in diameter. The top portion 306 is ⅜″ in diameter and about ¾″ in length, while the beveled hole 308 is about ¼″ in diameter. Other shapes and sizes can be used as well; for instance, the floss stick 300 can be rectangular or triangular prism shaped. Deviations in measurements can be accomplished as well based on the preferences of the manufacturer.

Alternatively, a floss stick may incorporate both the slot from the embodiment in FIG. 2 and the beveled hole from the embodiment in FIG. 3 such that a user can choose whether to wrap floss around the slot or through the beveled hole, or a combination of the two, based on the preferences of the user.

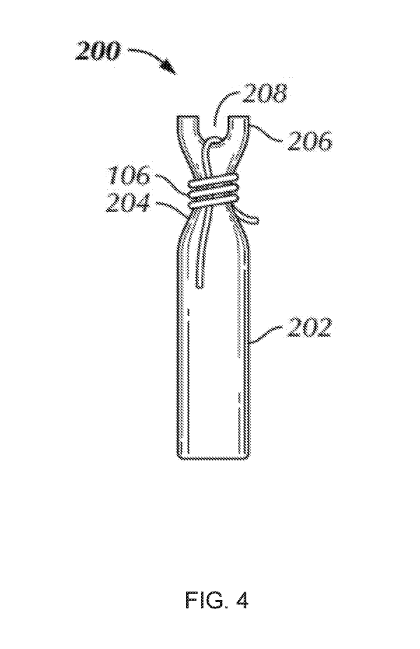

FIG. 4 is a perspective view of the floss stick 200 where the floss 106 is wrapped around the narrow neck portion 204 and through the slot 208. To wrap the floss 106 around the floss stick 200, the user begins by extracting a segment of floss 106 from any type of floss dispenser. The user then places a portion of floss along the slot 208 while one end of the floss 106 hangs along the length of the narrow portion 204 and elongated base portion 202 and is held in place, for example, by the user's thumb. A majority of the floss 106 is then tightly wound around the narrow portion 204 numerous times. While only three initial windings are shown in FIG. 4 for clarity, a majority of the floss 106 is subsequently wound around the first floss stick 200 while still leaving some floss to wrap around a second floss stick (not shown in this figure). A small portion of the floss 106 is threaded and wrapped similarly around the second floss stick. Once ready for use, the flossing apparatus should look like FIG. 1.

For threading the floss stick 300 with the beveled hole 308, the user threads a small tail portion of floss 106 through the beveled hole 308 on the top portion 306 of the first floss stick 300. The user then bends the tail portion of the floss down along the length of the narrow portion 304 and elongated base portion 302, holds this in place for example with his or her thumb, and then winds floss around the narrow portion 304 of the floss stick 300. The user then continues to wrap a majority of the floss 106 around the first floss stick 300. The slot 208 is generally preferable to the beveled hole 308 because threading the floss 106 is easier, takes less time, and the floss 106 has less of a tendency to curl since the tail of the floss 106 can be held under tension as it enters the slot 208. However either or both options are included herein.

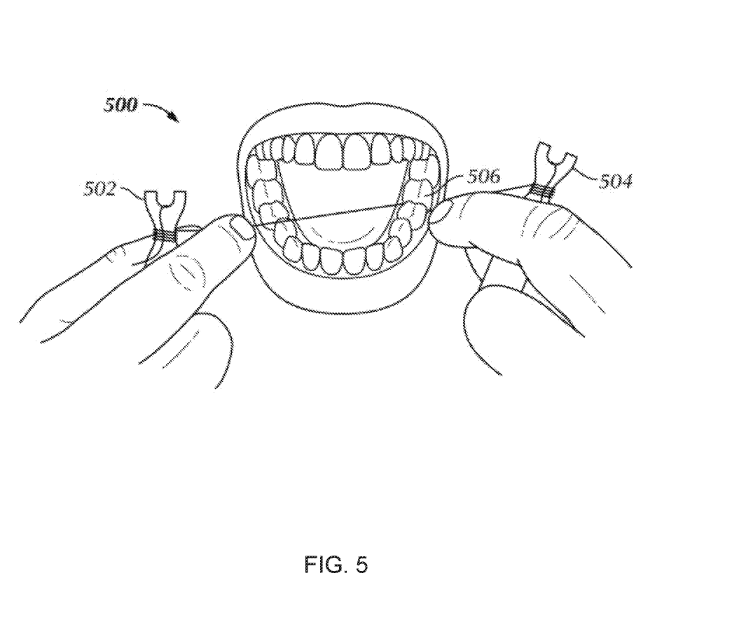

FIG. 5 is a perspective view of a flossing apparatus 500 of an embodiment of the present invention in use as a user flosses their teeth. The user flosses his or her teeth by using his or her thumbs (for the top teeth) or forefingers (for the bottom teeth) placed on the floss 506 between the first floss stick 502 and second floss stick 504 to guide the floss 506. This is the most effective way to find the each location for flossing, far superior to attempting accomplish this while holding remote handles. The two floss sticks 502 and 504 are easily rotated between flossing actions, moving fresh floss portions from the first floss stick 502 and used floss to the second floss stick 504 between flossing each gap between teeth, or when the user decides to use a fresh floss portion. The floss sticks 502 and 504 are generally not placed in the user's mouth, greatly reducing the gag reflex. Since the floss sticks 502 and 504 are easily gripped, the experience has the flexibility and ease of manual flossing without the pain associated with pressure from the coils of fresh and used floss around the fingers and with a greatly reduced tendency to activate the gag reflex. It also permits fresh floss portions to be presented at each gap between teeth without pulling out more floss from the plastic dispenser or using multiple floss picks, thus preventing unnecessary waste. When flossing is completed, the floss 506 can be easily and quickly pulled straight, vertically upwards off the tops of the floss sticks 502 and 504, and then dropped into a trash receptacle.

In an alternative embodiment, the floss sticks 502 and 504 include a small clip (not shown) in the top portion to begin wrapping the floss 506 instead of a beveled hole or slot seen in previous embodiments of the present invention. The clip would be located near the top portion of the floss sticks 502 and 504 and could be fashioned such that the end of the floss 506 is held in place by pressing it into the clip. The bulk of the floss 506 could then be wrapped around the narrow neck portion.

In another embodiment of the present invention, the floss sticks 502 and 504 include a spring-loaded top portion (not shown) used to pinch the floss 506 in placed prior to wrapping. Some modest force would be required to create a gap between the top portion and narrow neck of the floss sticks 502 and 504. The end of the floss 506 would then be inserted into this gap, and the head allowed to return to position.

Additionally, one or both of the floss sticks 502 and 504 can comprise a hollow compartment (not shown) pre-loaded with a reel of dental floss inside. The user can then extract floss from the compartment and use a pre-installed cutter (not shown) to cut the floss either before or after use. The compartment can be included in the elongated base portion, with the exit of the floss occurring at any location where it is convenient for the user to extract floss.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. An apparatus for dental flossing, comprising:
a first floss stick, wherein the first floss stick comprises:
an first elongated base portion;
a first top portion, wherein the first top portion includes a slot on which to thread floss; and
a first narrow neck portion between the first elongated base portion and first top portion, wherein the first narrow neck portion curves inward such that the width of the first narrow neck portion is less than the width of the first elongated base portion and first top portion;
a second floss stick, wherein the second floss stick comprises:
a second elongated base portion;
a second top portion, wherein the second top portion includes a slot on which to thread floss; and
a second narrow neck portion between the second elongated base portion and second top portion, wherein the second narrow neck portion curves inward such that the width of the second narrow neck portion is less than the width of the second elongated base portion and second top portion; and
a segment of floss wrapped between the first floss stick and second floss stick, such that the segment of floss is initially wrapped over the slot and around the first narrow neck portion of the first floss stick, and then wrapped over the slot and around the second narrow neck portion of the second floss stick.

2. The apparatus of claim 1, wherein the first and second floss sticks are identical.

3. The apparatus of claim 1, wherein the first and second floss sticks are cylindrical or of other cross-sectional shape.

4. The apparatus of claim 1, wherein the first and second elongated base portions each further comprise gripping means.

5. The apparatus of claim 1, wherein the first and second floss sticks are manufactured from molded plastic.

6. The apparatus of claim 1, wherein the first and second top portions each comprise a clip to hold the segment of floss in place while wrapping around the first and second narrow neck portions.

7. The apparatus of claim 1, wherein the first and second top portions are spring-loaded such that the segment of floss is pinched in place prior to wrapping.

8. The apparatus of claim 1, wherein either or both floss sticks further comprise a hollow compartment for containing a reel of dental floss.

9. The apparatus of claim 8, wherein the hollow compartment further comprises a cutter to cut a segment of floss.

10. The apparatus of claim 1, wherein a majority of the segment of floss is to be wrapped around the first floss stick.

11. The apparatus of claim 1, wherein the first and second floss sticks each further comprise a beveled hole through which to thread floss.

12. An apparatus for dental flossing, comprising:
a first cylindrical floss stick, wherein the first cylindrical floss stick comprises:
a first elongated base portion;
a first top portion, wherein the first top portion includes a beveled hole through which to thread floss; and
a first narrow neck portion between the first elongated based portion and first top portion, wherein the first narrow neck portion curves inward such that the diameter of the first narrow neck portion is less than the diameter of the first elongated base portion and first top portion;
a second cylindrical floss stick, wherein the second cylindrical floss stick comprises:
a second elongated base portion;
a second top portion, wherein the second top portion includes a beveled hole through which to thread floss; and
a second narrow neck portion between the second elongated based portion and second top portion, wherein the second narrow neck portion curves inward such that the diameter of the second narrow neck portion is less than the diameter of the second elongated base portion and second top portion; and
a segment of floss wrapped between the first cylindrical floss stick and second cylindrical floss stick, such that the segment of floss is initially wrapped through the beveled hole and around the first narrow neck portion of the first cylindrical floss stick, and then wrapped through the beveled hole and around the second narrow neck portion of the second cylindrical floss stick.

13. The apparatus of claim 12, wherein the first and second cylindrical floss sticks are identical.

14. The apparatus of claim 12, wherein the first and second elongated base portions each further comprise gripping means.

15. The apparatus of claim 12, wherein the first and second cylindrical floss sticks are manufactured from molded plastic.

16. The apparatus of claim 12, wherein either or both cylindrical floss sticks further comprise a hollow compartment for containing a reel of dental floss.

17. The apparatus of claim 12, wherein a majority of the segment of floss is to be wrapped around the first cylindrical floss stick.

18. A method for dental flossing, comprising the steps of:
gripping the apparatus of claim 1 by the elongated base portions of the first and second floss sticks in each hand;
separating the first and second floss sticks to maintain tension in the dental floss between the first and second floss sticks;
flossing teeth by using thumbs or forefingers placed on the floss between the first and second floss sticks to guide the floss;
rotating the first and second floss sticks to move fresh floss from the first floss stick and used floss to the second floss stick between flossing of gaps between the teeth; and
removing used floss when finished by pulling the floss straight upwards off the tops of the first and second floss sticks.

19. The method of claim 18, wherein the first and second floss sticks are cylindrical or of other cross-section shape.

20. The method of claim 18, further comprising the step of wrapping floss around the first and second floss sticks by:
extracting a segment of floss from a floss dispenser;
placing a portion of floss along the slot of the first floss stick while a first end of the floss hangs along the length of the narrow portion and elongated base portion of the first floss stick;
tightly winding a majority of the floss around the narrow neck portion of the first floss stick;
placing a remaining portion of floss along the slot of the second floss stick while a second end of the floss hangs along the length of the narrow portion and elongated base portion of the second floss stick; and
tightly winding the remainder of the floss around the narrow neck portion of the second floss stick.
